(19) United States
(12) Patent Application Publication
(10) Pub. No.: US 2025/0077866 A1
(43) Pub. Date: Mar. 6, 2025

(54) ARTIFICIAL INTELLIGENCE DEVICE FOR EVALUATION AND MODEL SELECTION AND CONTROL METHOD THEREOF

(71) Applicant: LG ELECTRONICS INC., Seoul (KR)

(72) Inventors: Harmanpreet SINGH, Toronto (CA); Amirhossein HAJAVI, Toronto (CA); Homa FASHANDI, Toronto (CA)

(73) Assignee: LG ELECTRONICS INC., Seoul (KR)

(21) Appl. No.: 18/827,305

(22) Filed: Sep. 6, 2024

(30) Foreign Application Priority Data
Sep. 6, 2023 (KR) 10-2023-0118536

(51) Int. Cl. G06N 3/08

(52) U.S. Cl. CPC G06N 3/08

(57) ABSTRACT

A method for controlling an artificial intelligence (AI) device can include obtaining, via a processor in the AI device, an AI model trained on a dataset that includes a majority class and at least one minority class, generating, via the processor, at least one evaluation metric for the AI model based multiplying a first score for positive samples of a target class within the dataset by a number of negative samples of the target class within the dataset and multiplying a second score for the negative samples within the dataset by a number of the positive samples, and outputting, via an output unit in the AI device, the at least one evaluation metric. Also, the method can further include adding the trained AI model to a pool of trained AI models and selecting a best AI model from the pool for deployment based on the at least one evaluation metric.

### CROSS-REFERENCE TO RELATED APPLICATIONS

This application claims priority to Korean Application No. 10-2023-0118536, filed in the Republic of Korea, on Sep. 6, 2023, the entirety of which is hereby expressly incorporated by reference into the present application.

### BACKGROUND

### Field

The present disclosure relates to an evaluation device and method, in the field of artificial intelligence (AI). Particularly, the method can evaluate and select a model from among multiple models trained based on imbalanced data, in the AI field. Further, the method can generate evaluation metrics for multi-label emotion recognition models and select a best performing model for deployment based on the evaluation metrics, in the AI field.

### Discussion of the Related Art

Artificial intelligence (AI) continues to transform various aspects of society and helps users more efficiently retrieve information and carry out tasks whether in the form of virtual assistants, monitoring systems, question and answering systems, or recommendations systems.

While AI has revolutionized various fields, issues still remain regarding the accuracy of AI models and reliable evaluation metrics for those AI models, particularly when an AI model has been trained on imbalanced data.

AI models trained on imbalanced data, where one class or category has significantly more samples than others, often encounter several accuracy related issues and can be biased. Also, it can be difficult to effectively and reliably evaluate the accuracy of an AI model trained on biased training data. For example, access to balanced, high-quality training data is often limited, highly restrictive or burdensome, forcing AI models to rely on imbalanced datasets for training. In other words, the accuracy of an AI model can depend on the quality of the data that was used to train the AI model.

An AI system trained on imbalanced data can be biased towards the majority class in the training data. For example, the AI model may tend to learn to predict the majority class more often, even when it is not the correct prediction. In other words, the AI model can be biased because it was exposed to more examples of the majority class during training, which can cause the AI model to favor the majority class.

In addition, existing evaluation techniques often provide misleading accuracy metrics for an AI model trained on imbalanced data. The overall accuracy based on existing evaluation techniques can be misleadingly high for imbalanced data sets because the AI model can achieve good accuracy by simply predicting the majority class most of the time, which can mask the AI model's poor performance on the minority classes. In other words, an AI model may be rewarded for being biased. For example, the AI model may be evaluated as having a high accuracy score, even when the AI model fails to detect rare but critical events. This can lead to catastrophic results in high stakes situations (e.g., relying on AI to carry out safety related tasks, maintenance tasks, health monitoring, security, etc.).

Further, effectively evaluating the performance of an AI model is even more difficult in multi-label classification settings. For example, imbalanced training data can significantly impact emotion recognition and the evaluation thereof when there are multiple classes involved, such as anger, disgust, fear, happiness, sadness and surprise.

An emotion recognition AI model that has been trained on imbalanced data may overemphasize common emotions (e.g., happy, sad) and have difficultly interpreting minority emotions (e.g., fear, surprise). Evaluating AI models for emotion recognition trained on imbalanced data poses challenges due to misleading overall accuracy metrics, neglect of minority emotions, class imbalance bias, and lack of focus on rare but important emotions (e.g., detecting rare but critical states or events).

Thus, a need exists for a more effective evaluation framework for AI models trained on imbalanced data. Also, a need exists for improved evaluation metrics that better represent an AI model's performance in multi-label classification settings that provide a more comprehensive assessment.

In addition, there exists a need for the ability to effectively evaluate a best AI model from among a pool of available AI models to select for deployment, which could improve accuracy, ensure more reliable detection and response to rare but critical events, and accelerate the adoption of AI technologies across diverse fields.

### SUMMARY OF THE DISCLOSURE

The present disclosure has been made in view of the above problems and it is an object of the present disclosure to provide a device and method that can provide an evaluation device and method, in the field of artificial intelligence (AI). Further, the method can provide more accurate metrics for evaluating an AI model trained on imbalanced data. Also, the method can generate evaluation metrics for multi-label emotion recognition models and select a best performing model for deployment based on the evaluation metrics, in the AI field.

Another object of the present disclosure is to provide a method for controlling an artificial intelligence (AI) device that includes obtaining, via a processor in the AI device, an AI model trained on a dataset that includes a majority class and at least one minority class, generating, via the processor, at least one evaluation metric for the AI model based multiplying a first score for positive samples of a target class within the dataset by a number of negative samples of the target class within the dataset and multiplying a second score for the negative samples within the dataset by a number of the positive samples, and outputting, via an output unit in the AI device, the at least one evaluation metric.

An object of the present disclosure is to provide a method in which the generating the at least one evaluation metric for the AI model includes generating a Cross F1 score for the AI model based on the dataset, the Cross F1 score is defined by equation:

$$Cross {f}_{1} = \frac{( {f}_{1}^{p} \times {N}^{n} ) + ( {f}_{1}^{n} \times {N}^{p} )}{{N}^{p} + {N}^{n}} ,$$

where f₁^{p} is an F1 score generated when measuring performance of the AI model on the positive samples, is an F1 score generated when measuring performance of the AI model on the negative samples, N^{p} is the number of the positive samples and Nⁿ is the number of the negative samples, and the F1 score is defined by equation:

$$F 1 Score = \frac{T P}{T P + \frac{1}{2} ( FP + FN )} ,$$

where TP is a number of true positives, FP is a number of false positives, and FN is a number of false negatives.

An object of the present disclosure is to provide a method in which the generating the at least one evaluation metric for the AI model further includes generating a Macro F1 score for the AI model based on the dataset, in which the Macro F1 score is defined by equation:

$$Macro {f}_{1} = \frac{{f}_{1}^{p} + {f}_{1}^{n}}{2} ,$$

and the at least one evaluation metric is based on both the Cross F1 score and the Macro F1 score.

Another object of the present disclosure is to provide a method in which the Cross F1 score is a value between 0 and 1.

An object of the present disclosure is to provide a method that includes comparing the at least one evaluation metric to a predefined threshold value, and in response to the at least one evaluation metric being greater than the predefined threshold value, deploying the AI model in a multi-label emotion recognition system, a question and answer system or a recommendation system.

Another object of the present disclosure is to provide a method for controlling an artificial intelligence (AI) device that includes obtaining, via a processor in the AI device, a dataset that includes a majority class and at least one minority class, training, via the processor, an AI model based on the dataset to generate a trained AI model, generating, via the processor, an evaluation result for the trained AI model based on a Cross F1 metric and a Macro F1 metric, in response to the evaluation result meeting or exceeding predefined criteria, adding the trained AI model to a pool of trained AI models trained on the dataset to generate an updated pool including a plurality of trained AI models, selecting a selected AI model from among the plurality of trained AI models in the updated pool based on the Cross F1 metric and the Macro F1 metric, and deploying the selected AI model in the AI device or transmitting the selected AI model to an external device.

An object of the present disclosure is to provide a method in which the Cross F1 metric is defined by equation:

$$Cross {f}_{1} = \frac{( {f}_{1}^{p} \times {N}^{n} ) + ( {f}_{1}^{n} \times {N}^{p} )}{{N}^{p} + {N}^{n}} ,$$

where f₁^{p} is an F1 score generated when measuring performance of the AI model on positive samples of a target class within the dataset, f₁^{p} is an F1 score generated when measuring performance of the AI model on negative samples of the target class within the dataset, N^{p} is a number of the positive samples and Nⁿ is a number of the negative samples, and the F1 score is defined by equation:

$$F 1 Score = \frac{TP}{TP + \frac{1}{2} ( FP + FN )} ,$$

where TP is a number of true positives, FP is a number of false positives, and FN is a number of false negatives, and the Macro F1 metric is defined by equation:

$$Macro {f}_{1} = \frac{{f}_{1}^{p} + {f}_{1}^{n}}{2} .$$

Another object of the present disclosure is to provide a method in which the selecting the selected AI model is based on at least one of a highest average of the Cross F1 metric and the Macro F1 metric, applying different weight coefficients to the Cross F1 metric and the Macro F1 metric, a highest harmonic mean of the Cross F1 metric and the Macro F1 metric, and a highest weighted harmonic mean of the Cross F1 metric and the Macro F1 metric.

An object of the present disclosure is to provide a method that includes splitting the dataset into a training dataset, a validation dataset and a test dataset, in which the AI model trained based on the training dataset, the predefined criteria for adding the AI model to the pool is based on the validation dataset, and the deploying the selected AI model is based on an evaluation using the test dataset.

Yet another object of the present disclosure is to provide a method in which the selected AI model is deployed in a multi-label emotion recognition system, a question and answer system or a recommendation system.

An object of the present disclosure is to provide a method that includes continuing training of the AI model until performance is satisfactory or until a predetermined number of iterations has been reached to generate the trained AI model, the continuing training of the AI model includes tuning hyper-parameters of the AI model, and in response to the performance being satisfactory or when the predetermined number of iterations is reached, adding the trained AI model to the pool.

Another object of the present disclosure is to provide a method that includes saving a checkpoint of the trained AI model in a memory of the AI device before generating the evaluation result for the trained AI model.

An object of the present disclosure is to provide a method in which the AI model is a multi-label emotion recognition configured to identify emotions including anger, disgust, fear, happiness, sadness and surprise, and the dataset is an imbalanced dataset including one or more of textual passages, images, audio recordings, and video recordings.

Another object of the present disclosure is to provide an artificial intelligence (AI) device that includes a memory configured to store evaluation metrics, and a controller configured to obtain a dataset that includes a majority class and at least one minority class, receive an AI model, train the AI model based on the dataset to generate a trained AI model, generate an evaluation result for the trained AI model based on a Cross F1 metric and a Macro F1 metric, in response to the evaluation result meeting or exceeding predefined criteria, add the trained AI model to a pool of trained AI models trained on the dataset to generate an updated pool including a plurality of trained AI models, select a selected AI model from among the plurality of trained AI models in the updated pool based on the Cross F1 metric and the Macro F1 metric, and deploy the selected AI model in the AI device or transmit the selected AI model to an external device.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 shows an example flow chart for a method in the AI device, according to an embodiment of the present invention.

FIG. 5 shows an example flow chart for a method in the AI device, according to an embodiment of the present invention.

FIG. 6 shows an example flow chart for a method in the AI device regarding training and model selection, according to an embodiment of the present invention.

FIG. 7 shows an example flow chart for a method in the AI device regarding a training loop for training an AI model, according to an embodiment of the present invention.

FIG. 8 illustrates evaluation results of classifiers against a synthetic training set according to comparative examples and embodiments of the present disclosure.

FIG. 9 illustrates a distribution of samples in different emotion classes of the CMU-MOSEI Dataset.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

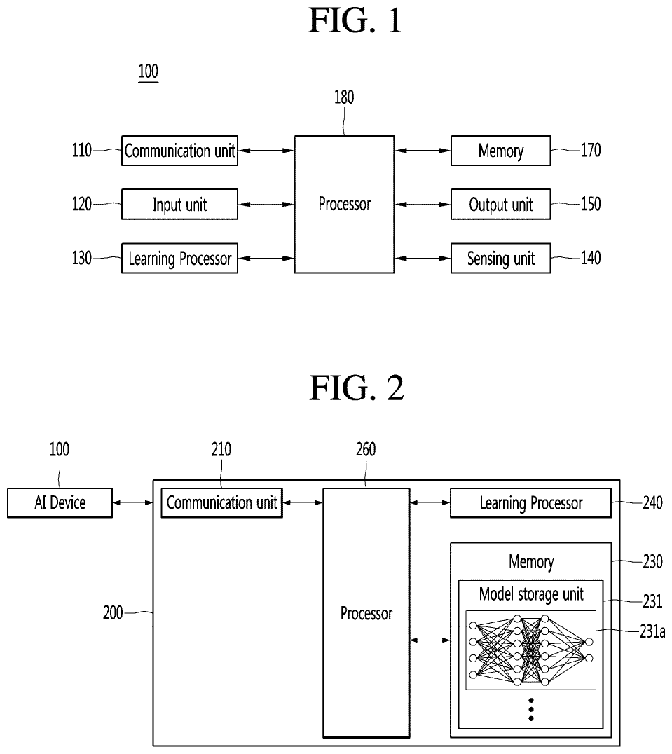

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

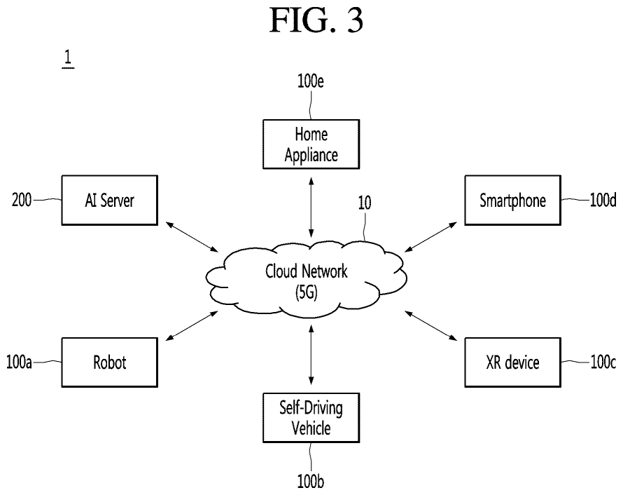

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can generate evaluation metrics for evaluating the performance of an AI model. Also, processor 180 can select a best AI model from among a plurality of AI models based on the evaluation metrics. The AI models can be multi-modal emotion recognition AI models, but embodiments are not limited thereto.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information for the user input and can determine an answer or a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

Also, according to an embodiment, the AI device 100 can obtain a knowledge graph, which can include a web of interconnected facts and entities (e.g., a web of knowledge). A knowledge graph is a structured way to store and represent information, capturing relationships between entities and concepts in a way that machines can understand and reason with.

According to an embodiment, the AI device 100 can include one or more knowledge graphs that include entities and properties or information about people or items (e.g., names, user IDs), products (e.g., display devices, home appliances, etc.), profile information (e.g., age, gender, weight, location, etc.), recipe categories, ingredients, images, purchases and reviews.

According to an embodiment, a knowledge graph can capture real world knowledge in the form of a graph structure modeled as (h, r, t) triplets where h and t refer to a head entity and a tail entity respectively, and r is a relationship that connects the two entities.

Also, knowledge graph completion can refer to a process of filling in missing information in a knowledge graph, making it more comprehensive and accurate (e.g., similar to piecing together a puzzle, uncovering hidden connections and expanding the knowledge base). Link prediction can identify missing links in a knowledge graph (KG) and assist with downstream tasks such as question answering and recommendation systems.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the evaluation method can be implemented as an application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the learning model to the AI devices 100a to 100c.

At this time, the AI server 200 can receive input data from the AI devices 100a to 100c, can infer the result value for the received input data by using the learning model, can generate a response or a control command based on the inferred result value, and can transmit the response or the control command to the AI devices 100a to 100c. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of an evaluation method, a selection method, a virtual assistant, a security system, a patient monitoring system, a driver assistance system, a predictive maintenance system, a question and answering system or a recommendation system. The method can be the form of an executable application or program.

The robot 100a, to which the AI technology is applied, can be implemented as an entertainment robot, a guide robot, an assistance robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query. The answer can be in the form of natural language.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

According to an embodiment, the AI device 100 can generate evaluation results for evaluating the performance of a trained AI model. According to another embodiment, the AI device 100 can generate evaluation results for a pool of trained AI models trained on imbalanced data and select a best AI model for deployment from among the pool based on the evaluation results, and can carry out an operation or action using the selected AI model. Also, according to an embodiment, the AI device 100 can generate evaluation metrics for multi-label emotion recognition models and select a best performing model for deployment based on the evaluation metrics.

For example, once a best performing AI model is selected, it can then be deployed in an AI device, such as a smart home device (e.g., as a personal assistant), a smart TV (e.g., as a recommendation system or question and answering system), a wearable device (e.g., a health monitoring device), a security system, a vehicle (e.g., driver assistance system, or monitoring system), etc.

According to another embodiment, the AI device 100 can be integrated into an infotainment system of the self-driving vehicle 100b, which can ensure reliable detection and response to rare but critical driving scenarios and events, recommend content or provide answers based on various input modalities, the content can include one or more of audio recordings, video, music, pod casts, etc., but embodiments are not limited thereto. Also, the AI device 100 can be integrated into an infotainment system of the manual or human-driving vehicle. Further the AI device 100 can be integrated into various types of vehicles or systems and can perform predictive maintenance and monitoring including accurate prediction and detection of rare but critical events (e.g., failures). Also, the AI device 100 can be integrated into a security system to perform accurate prediction and detection of rare but critical events (e.g., break-ins or emergencies).

Evaluating AI models trained on imbalanced data presents significant challenges. For example, AI models trained on imbalanced data can have accuracy issues and exhibit bias, and existing evaluation techniques can exasperate the issue by rewarding such bias. Existing evaluation techniques often provide misleading accuracy metrics for an AI model trained on imbalanced data because the AI model may achieve good accuracy by simply predicting the majority class most of the time, which can mask the AI model's poor performance on the minority classes. For example, the AI model may be evaluated as having a high accuracy score, even when the AI model fails to detect rare but critical events. This can lead to catastrophic results in high stakes situations (e.g., relying on AI to carry out safety related tasks, maintenance tasks, health monitoring, security, etc.).

According to an embodiment, the AI device 100 can address the challenge of evaluating AI models trained on imbalanced data by using an improved evaluation framework and selection process. The present disclosure discusses an AI device and method applied to multi-model emotion recognition (ER), but this is merely a non-limiting example and embodiments of the present disclosure are applicable to various domains dealing with imbalanced data.

Multi-modal emotion recognition (ER) AI models aim to detect the emotional state of individuals or users from audio, visual, and literal information. However, class imbalances in existing multi-label ER evaluation benchmarks has adversely affected the evaluation process of these AI models. For example, existing multi-label ER evaluation benchmarks such as weighted accuracy and weighted F1, can be effective on single-label classification tasks but fail to show multi-label model performance accurately.

Human emotion can be conveyed through facial, vocal and literal expressions, which can include six primary emotions of anger, disgust, fear, happiness, sadness and surprise. Also, more complex emotions can be represented as a combination of the primary emotion classes, enabling automated systems to formulate emotion recognition (ER) as a multi-class, multi-label classification task. However, the training and evaluation of such AI models are heavily dependent on the availability of training data (e.g., data collected from public platforms, videos posted online, social media posts or mainstream media, etc.).

For example, videos collected from public platforms are often imbalanced with regards to expressing different classes of emotions. Individuals on public platforms may express common emotions such as happiness and sadness more frequently than less common emotions such as fear and surprise, which can result in an emotion-class imbalance. Also, there can be a significant imbalance between negative and positive samples for each type of emotion class in the context of multi-label emotion recognition.

Further, the evaluation of trained AI models for multi-modal emotion recognition can be limited due to the class imbalance in available training datasets. For example, evaluation metrics such as a weighted accuracy score and a weighted F1 score can be used for evaluation of trained AI models. Weighted accuracy and weighted F1 scores can be suitable for single-label imbalanced classification, but these metrics can fail to truthfully reflect the AI model's actual performance in multi-label settings.

According to an embodiment, a method for controlling an artificial intelligence (AI) device can including selecting an AI model based on weighted accuracy. Weighted accuracy is a metric that calculates the average accuracy of all classes while giving more importance or weight to classes with fewer samples, in order to try and address class imbalance in a dataset. Weighted accuracy is defined in Equation 1, below.

$$Weighted Accuracy = \frac{1}{N} {\sum }_{i = 1}^{N} {w}_{i} \cdot \frac{{TP}_{i} + {TN}_{i}}{{TP}_{i} + {TN}_{i} + {FP}_{i} + {FN}_{i}} \qquad [ Equation 1 ]$$

In Equation 1 above, TP is the number of true positives, TN is the number of true negatives, FP is the number of false positives, FN is the number of false negatives, N is the total number of instances, and w; is the weight for each class i, where i is a positive number.

Weighted accuracy is a modification of the standard accuracy metric that takes into account the class distribution in the dataset. For example, standard accuracy measures the overall proportion of correct predictions, and weighted accuracy adjusts accuracy based on the number of samples in each class by giving more weight to underrepresented classes (e.g., underrepresented emotions).

For example, in the context of emotion recognition, for a data sample that includes a person who is smiling, a true positive TP would be when the model accurately identifies the person as “happy.” Also, a true negative TN would be when the model correctly predicts the absence of a particular emotion, e.g., a person having a neutral expression and the AI model correctly identifies that the person is not happy. Further, a false negative FN is when the AI model fails to predict an emotion when it is actually present, and a false positive FP is when the AI model incorrectly predicts the presence of an emotion when it is not there.

These metrics can be used to evaluate an AI model, e.g., high TP and high TN can indicate that the AI model is performing well overall, a high FP might mean the AI model is too sensitive and over-predicts certain emotions, and a high FN might suggest that the AI model is not sensitive enough and is missing some emotional cures. Also, emotion recognition is merely an example, and embodiments are not limited thereto.

However, while weighted accuracy can be useful for addressing class imbalance in single-label scenarios, it faces challenges in multi-label settings due to the complexity of multiple labels per instance and label correlations, making it difficult to assign appropriate weights (e.g., six or more different types of emotions). Also, interpreting overall performance versus class-specific performance using weighted accuracy can be ambiguous, and the model may exhibit overfitting on minority classes or bias for the majority class.

According to another embodiment, a method for controlling an AI device can including selecting an AI model based on a weighted F1 score. Weighted F1 (wf₁) is a metric that calculates the average F1 score across all classes while giving more importance or weight to the F1 scores of classes with fewer samples, and the F1 score is the harmonic mean of precision and recall. Weighted F1 (wf₁) is defined in Equation 2, below.

$$ω {f}_{1} = \frac{( {f}_{1}^{p} \times {N}^{p} ) + ( {f}_{1}^{n} \times {N}^{n} )}{{N}^{p} + {N}^{n}} \qquad [ Equation 2 ]$$

In Equation 2 above, f₁^{p} is the F1 score calculated when measuring the AI model's performance on positive samples of the target class, and f₁ⁿ considers the negative samples of that class in the test dataset. The scalars N^{p} and Nⁿ are the number of positive and negative samples in the class, respectively.

When models are biased towards the more represented class in the test set, evaluations utilizing the weighted F1 and weight accuracy metrics can result in higher values for these classes. In the context of multi-label emotion recognition, less represented emotions such as anger and surprise commonly have fewer instances during training and testing, which can lead to a higher representation of negative labels for these classes. AI models with a bias towards predicting more negative answers for these unrepresented classes may be evaluated with high metric scores, even if the actual performance of these AI models is relatively poor overall (e.g., overfitting to minority classes or missing rare but critical emotions).

According to an embodiment, the AI device 100 can implement a method that can include using an improved metric for evaluating an AI model trained on imbalanced data by using a Cross F1 score. This Cross F1 metric can be used to select a best AI model from among a pool of trained AI models. Cross F1 is defined in Equation 3, below.

$$Cross {f}_{1} = \frac{( {f}_{1}^{p} \times {N}^{n} ) + ( {f}_{1}^{n} \times {N}^{p} )}{{N}^{p} + {N}^{n}} \qquad [ Equation 3 ]$$

In Equation 3 above, f₁^{p} is the F1 score calculated when measuring the AI model's performance on positive samples of the target class, and f₁ⁿ considers the negative samples of that class in the test dataset. The scalars N^{p} and Nⁿ are the number of positive and negative examples in the evaluation set, respectively. Here, in Cross F1, the scalar Nⁿ is applied to the F1 score calculated while measuring the AI model's performance on positive samples of the target class, and the scalar N^{p} is applied to the F1 score calculated while measuring the AI model's performance on negative samples of the target class.

For example, Cross F1 can balance the AI model's performance between positive and negative classes. This is achieved by multiplying the f^{p} (positive class) and fⁿ (negative class) with Nⁿ and N^{p}, respectively. In this way, Cross F1 can help reduce the impact of any possible bias of the AI model towards one class due to the low weight of the other class.

In addition, the Cross F1 values can range from 0 to 1. For example, a value closer to 1 can indicate better prediction accuracy for both classes. Furthermore, when Cross F1 is close to 0, it can indicate poor performance on both positive and negative samples, unlike other metrics where the most represented class determines the score value (e.g., in other evaluation metrics the score of the overrepresented class can undesirably dominate the overall score). For imbalanced multi-label problems, the Cross F1 evaluation metric requires strong performance on both positive and negative samples in order to score high.

Cross F1 can adjust for class imbalance based on the number of samples in order to ensure that representation for each class is more fair. For example, Cross F1 is tailored to handle class imbalance by weighting the F1 scores according to the number of samples in the other classes. Cross F1 gives more importance to the F1 score of the minority class to ensure that the AI model's performance is not skewed by the majority class.

According to an embodiment, a method of controlling an AI device can include obtaining a plurality of AI models trained on an imbalanced dataset, generating Cross F1 scores according to Equation 3 for each of the plurality of AI models, and selecting an AI model having a highest Cross F1 score from among the plurality of AI models. Also, the method can further include deploying the selected AI model having the highest Cross F1 score in the AI device itself or transmitting the selected AI model to an external device.

For example, the selected AI model can be deployed in a smart home device (e.g., as a personal assistant), a smart TV (e.g., as a recommendation system or question and answering system), a wearable device (e.g., a health monitoring device), a security system, a vehicle (e.g., driver assistance system, or monitoring system), etc. Also, according to an embodiment, the selected AI model can be transmitted to an external device.

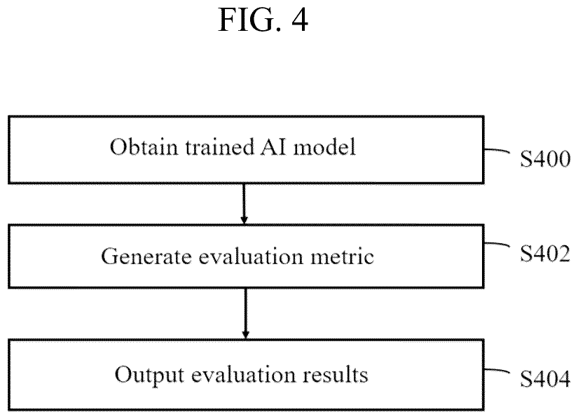

FIG. 4 shows an example flow chart of a method according to an embodiment. For example, the AI device 100 can be configured with a method that includes obtaining, via a processor in the AI device, an AI model trained on a dataset that includes a majority class and at least one minority class (e.g., S400), generating, via the processor, at least one evaluation metric for the AI model based multiplying a first score for positive samples of a target class within the dataset by a number of negative samples of the target class within the dataset and multiplying a second score for the negative samples within the dataset by a number of the positive samples (e.g., S402, generate Cross F1 score), and outputting, via an output unit in the AI device, the at least one evaluation metric (e.g., S404).

According to another embodiment, a method of controlling an AI device can include selecting an AI model based on a Cross F1 score and a Macro F1 score. For example, equal weights or different weights can be assigned to the Cross F1 score component and the Macro F1 score component when selecting an AI model to deploy, discussed in more detail in a later section.

For example, according to an embodiment, a method of controlling an AI device can include selecting an AI model based on a Macro F1 score. Macro F1 is a metric that calculates the average F1 score across all classes while giving equal weight to all classes, and the F1 score is the harmonic mean of precision and recall. Macro F1 is defined in Equation 4, below.

$$Macro {f}_{1} = \frac{{f}_{1}^{p} + {f}_{1}^{n}}{2} \qquad [ Equation 4 ]$$

In Equation 4 above, f₁^{p} is the F1 score calculated while measuring the AI model's performance on positive samples of the target class, and f₁ⁿ is the F1 score calculated while measuring the AI model's performance on the negative samples of that class in the test dataset.

For example, Macro F1 is the average of the F1 scores calculated independently for each class, in which all classes are treated equally regardless of their size or frequency in the training dataset. Macro F1 is useful when evaluating the AI model's performance equally across all classes (e.g., across all emotions), regardless of their frequency. This can be beneficial in situations where all classes are of equal importance.

As discussed above, according to an embodiment, a method of controlling an AI device can include selecting an AI model based on a combination of a Cross F1 score and a Macro F1 score. Different contributions of the Cross F1 score component and the Macro F1 score component can be used or adjusted, according to embodiments.

For example, according to an embodiment, a best AI model can be selected from among a pool of trained AI models that has a highest average of the Cross F1 score and the Macro F1 score (e.g., (Cross_F1+Macro_F1)/2), but embodiments are not limited thereto. Also, the AI device can select an AI model by assigning different weight coefficients to the Cross F1 score and the Macro F1 score (e.g., (w1*Cross_F1+w2*Macro_F1)/2).

Further, according to an embodiment, the selection criteria can include choosing an AI model that has a highest weighted harmonic mean of the two metrics (e.g., ((w1*Cross_F1)*(w2*Macro_F1))/(w1*Cross_F1+w2*Macro_F1)). Also, other combinations of the Cross F1 score and the Macro F1 score can be used for determining a best AI model to select for deployment, according to embodiments.

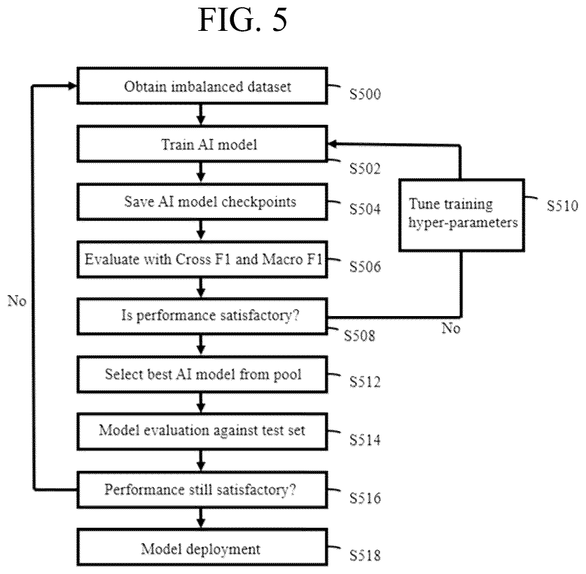

FIG. 5 shows an example flow chart of a method according to an embodiment of the present disclosure. For example, the AI device 100 can be configured with a method that includes obtaining an imbalanced dataset for training an AI model, and splitting the imbalanced dataset into a training dataset, a validation dataset and a test dataset (e.g., S500). For example, 70% of the original imbalanced dataset can be used for the training dataset, 15% can be used for the validation dataset, and the remaining 15% can be used for the test dataset, but embodiments are not limited thereto and different proportions can be allocated.

For example, in the context of emotion recognition, the imbalanced dataset can include one or more of textual passages, images, audio recordings, and video recordings that include different emotions (e.g., happy speech, an image or video of a happy person, angry speech, etc.). However, embodiments are not limited emotion recognition and the method can be applied to any type of AI model trained on imbalanced data.

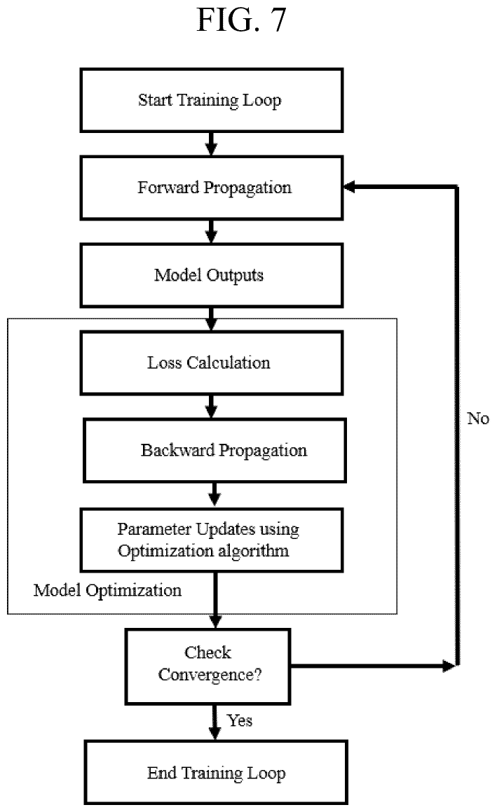

Further, the method can include training an AI model based on the training dataset (e.g., S502). The model's checkpoints (e.g., model weights, Epoch number, hyperparameters, etc.) for this trained AI model can be saved in storage memory (e.g., S504). An example of training of an AI model is discussed in more detail below with respect to FIG. 7.

The method can further include evaluating the trained AI model corresponding to the current checkpoint based on Cross F1 and Macro F1 (e.g., S506). Then the method can include determining whether the performance of the trained AI model is satisfactory or if training of the AI model has exceeded a predefined number of iterations, and the trained AI model can be added to a pool including a plurality of trained AI models (e.g., S508).

For example, the Cross F1 score can be compared to a first minimum threshold value and the Macro F1 score can be compared to a second minimum threshold value, and if both thresholds are met, then the performance can be deemed satisfactory and this version of the trained AI model can be added to a pool including a plurality of trained AI models that have been trained on the same imbalanced training dataset.

However, satisfactory performance of the AI model based on Cross F1 and Macro F1 can determined in various ways, according to embodiments. For example, a highest average of the Cross F1 score and the Macro F1 score (e.g., (Cross_F1+Macro_F1)/2) can be compared to a predefined threshold, different weight coefficients can be assigned to the Cross F1 score and the Macro F1 score (e.g., (w1*Cross_F1+w2*Macro_F1)/2) and the combined results can be compared to the predefined threshold, a weighted harmonic mean of the two metrics (e.g., ((w1*Cross_F1)*(w2*Macro_F1))/(w1*Cross_F1+w2*Macro_F1)) can be compared to the predefined threshold, and other combinations of the Cross F1 score and the Macro F1 score can be used for determining whether the performance is satisfactory, or whether training of the AI model needs to continue.

Otherwise, if the answer is “NO” at step S508, training of the AI model can continue and tuning of the model's hyper-parameters can be performed and updated as part of a training loop that returns to step S502. Also, once training of the AI model has exceeded a predefined number of iterations or is deemed satisfactory based on the test dataset, then the trained AI model can be saved and included in the pool. For example, even if the performance of AI model is never deemed to be satisfactory, the trained AI model can exit the training loop to be saved and added to the pool once its training has exceeded enough iterations (e.g., a predetermined number of iterations).

The method can further include selecting a best AI model from among the pool of trained AI models based on the validation dataset (e.g., S512). For example, the best AI model can be selected based on Cross F1 and Macro F1 in various ways, according to embodiments. For example, a best AI model can be selected from among the pool of trained AI models that has a highest average of the Cross F1 score and the Macro F1 score (e.g., (Cross_F1+Macro_F1)/2) based on the validation dataset, but embodiments are not limited thereto. Also, the AI device can select a best AI model by assigning different weight coefficients to the Cross F1 score and the Macro F1 score (e.g., (w1*Cross_F1+w2*Macro_F1)/2). Further, the selection criteria can include choosing a best AI model that has a highest weighted harmonic mean of the two metrics (e.g., ((w1*Cross_F1)*(w2*Macro_F1))/(w1*Cross_F1+w2*Macro_F1)), or a highest harmonic mean (e.g., (Cross_F1*Macro_F1)/(Cross_F1+Macro_F1)) for the validation dataset. Also, other combinations of the Cross F1 score and the Macro F1 score can be used for determining a best AI model to select for deployment.

Then the method can evaluate the selected model again based on the test dataset to determine whether performance is still satisfactory (e.g., S516). For example, the method can include generating a Cross F1 score and Macro F1 score based on the test dataset and the scores can be evaluated. For example, performance can be deemed to be satisfactory if both the Cross F1 score and Macro F1 score for the test dataset respectively meet first and second minimum threshold values, but embodiments are not limited thereto.

Also, the thresholds or criteria used in the evaluations at step S508, step S512 and step s516 can be the same or set different from each other. For example, the threshold(s) used at step S516 can be set higher than the threshold(s) used at step S512 and step S508, but embodiments are not limited thereto and different thresholds can be variously set for the evaluation using the training dataset (e.g., S508), the selection using the validation dataset (e.g., S512), and the determination using the test dataset (e.g., S516) according to design requirements.

As discussed above, satisfactory performance based on Cross F1 and Macro F1 can be determined in various ways, such as a highest average of the Cross F1 score and the Macro F1 score (e.g., (Cross_F1+Macro_F1)/2) exceeding a predefined threshold, different weight coefficients can be assigned to the Cross F1 score and the Macro F1 score (e.g., (w1*Cross_F1+w2*Macro_F1)/2) and the combined results can be compared to the predefined threshold, a weighted harmonic mean of the two metrics (e.g., ((w1*Cross_F1)*(w2*Macro_F1))/(w1*Cross_F1+w2*Macro_F1)) can be compared to the predefined threshold, and other combinations of the Cross F1 score and the Macro F1 score can be used for determining whether the performance is still satisfactory. For example, if the results based on a combination of the Cross F1 score and the Macro F1 score as applied to the test dataset exceed the predefined threshold, then the selected AI model can be deemed to still be satisfactory and can be deployed (e.g., S518).

For example, the selected AI model can be deployed in the AI device 100 itself or transmitted to an external device (e.g., S518). According to embodiments, the selected AI model can be deployed in a smart home device (e.g., as a personal assistant), a smart TV (e.g., as a recommendation system or question and answering system), a wearable device (e.g., a health monitoring device), a security system, a vehicle (e.g., driver assistance system, or monitoring system), but embodiments are not limited thereto.

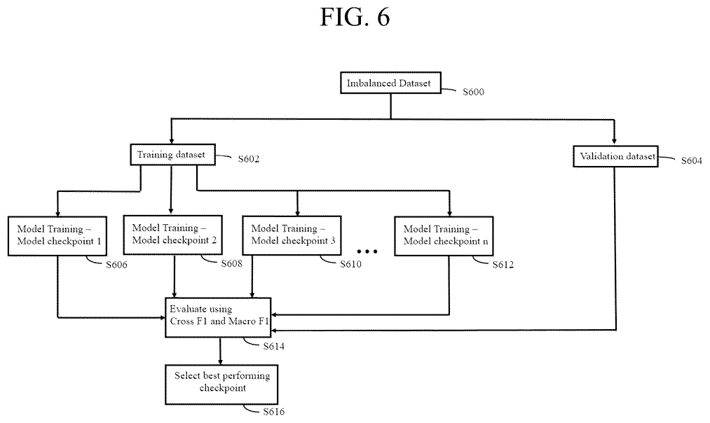

FIG. 6 shows the process of creating a pool of different trained AI models and selecting a best AI model from among the pool, in more detail, according to an embodiment of the present disclosure.

For example, the AI device 100 can receive an imbalanced dataset for training (e.g., S600), and split or divide the imbalanced dataset into a training dataset (e.g., S602), a validation dataset (e.g., S604) and a test dataset. The training dataset can include 70% of the samples from the imbalanced dataset, and the validation dataset can include 15% of the samples, but embodiments are not limited thereto.

The AI device 100 can use the same training dataset to create a pool of different trained AI models by training the models and saving each model at a different checkpoint. For example, a first trained AI model can be saved after it has been trained on the training dataset for 1,000 iterations (e.g., model checkpoint 1, S606), a second trained AI model can be saved after it has been trained on the training dataset for 2,000 iterations (e.g., model checkpoint 2, S608), a third trained AI model can be saved after it has been trained on the training dataset for 10,000 iterations (e.g., model checkpoint 3, S610), and so on, until a last trained AI model corresponding to n iterations (e.g., model checkpoint n, S612). For example, the different checkpoints can include different model weights and different tunings of the hyperparameters, etc.

Then, the method can include evaluating each of the different trained AI models based on Cross F1 and Macro F1 (e.g., S614), and a best performing AI model can be selected from the pool (e.g., S616). Different combinations and grading schemes based on the Cross F1 score and Macro F1 score can be used for determining the best AI model, as discussed above.

Once the best AI model is selected, then the AI model corresponding to the best performing checkpoint can be deployed. For example, the AI model can be deployed in the AI device 100 itself that preformed the evaluations or the AI model transmitted to an external device. For example, the selected AI model can be deployed to an entire fleet of AI devices, but embodiments are not limited thereto.

FIG. 7 shows an example process of training an AI model, in more detail, according to an embodiment of the present disclosure. For example, training of an AI model on a training dataset (e.g., step S502 from FIG. 5) can include a repetitive process referred to as a training loop.

Within each loop or iteration, the model can perform forward propagation where input data is passed through the model's layers to generate predictions or model outputs. Then, the model outputs can be compared to the actual labels or ground truth values, and a loss function calculation can quantify the discrepancy between them.

Further in this example, the loss can represent the error the model made in its predictions (e.g., model outputs). Then, backward propagation can be carried out, in which gradients can be calculated which can indicate how much each parameter contributed to the error.

In addition, the gradients can be used by an optimization algorithm (e.g., stochastic gradient decent) to update the AI model's parameters or weights in a way that reduces the loss.

Further in this example, the training loop can continue and the AI model's performance can be periodically checked to determine whether convergence has been reached indicating that the metrics have stabilized based on the loss function (e.g., when the loss stops decreasing significantly or reaches a plateau). Once convergence has been deemed to have been reached (e.g., when the error is less than a predefined threshold), then the training loop can end, the checkpoints for this AI model can be saved and the trained AI model can be added to the pool, as discussed above.

In addition, as discussed above, the method of using Cross-F1 and Macro-F1 offers various advantages, such as providing a more balanced evaluation of AI models trained on imbalanced datasets, according to embodiments. For example, the method can ensure that both positive and negative classes are equally represented, leading to a more accurate reflection of model performance. These advantages are demonstrated through experiments on an imbalanced emotion recognition dataset on a multi-label classification task.

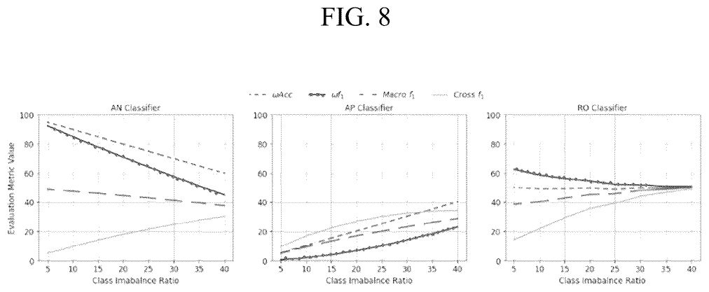

For example, FIG. 8 illustrates evaluation results of classifiers against a synthetic training set according to comparative examples and embodiments of the present disclosure.

In order to better understand how class imbalance can impact evaluation metrics, synthetic test sets were created that mimic the distribution of a single emotion class. Selected classifiers were used to predict labels in 3 different settings including: predict all negative labels, predict all positive labels, and predict positive labels with a 50% probability. These selected classifiers can be referred to as “All-Negative (AN),” “All-Positive (AP),” and “Random-Output (RO).” The selected classifiers were used in controlling experiments to remove uncertainty in choosing a model, training, and validation process.

In addition, ratios between 5% to 40% were used to simulate different levels of class imbalance. Performance was measured for the selected classifiers with constant outputs, analogous to biases that real models may learn. By fixing the classifiers and varying only the class ratio, any changes in metric values can be attributed to class imbalance. Metrics with minimal value change across different class imbalance levels are favored. In other words, the more the results change for a given metric as the different class imbalance levels are changed, then the metric is less reliable. For example, a good evaluation metric should remain relative stable even as the class imbalance levels are adjusted between 5% to 40%.

The AN, AP and RO classifiers were evaluated against the synthetic testing set using different evaluation metrics including weighted accuracy (ωAcc), weighted F1 (ωf1), Cross F1, and Macro F1, and the results are shown in FIG. 8. For example, the experiments used eight ratios of positive and negative samples.

As shown in FIG. 8 (left), the AN classifier exhibits high values for weighted accuracy (ωAcc) and weighted F1 (ωf1) when the ratio of positive to negative samples is 5%. However, a rapid decline in the values of weighted accuracy (ωAcc) and weighted F1 (ωf1) occurs when the testing set is shifted towards a more balanced state, which is undesirable and shows that weighted accuracy (ωAcc) and weighted F1 (ωf1) are not as reliable for different levels of class imbalance.

Regarding the AP classifier (e.g., FIG. 8, middle), the values of weighted accuracy (ωAcc) and weighted F1 (ωf1) start from very low values and then rapidly increase when more positive samples are added to the testing set, which further indicated that the weighted accuracy (ωAcc) and weighted F1 (ωf1) metric change too much for different levels of class imbalance.

In addition, the results of evaluating the selected classifiers using Macro F1 show that the metric's value at 5% imbalance ratio to 40% imbalance ratio is much more stable, than the metrics for weighted accuracy (ωAcc) and weighted F1 (ωf1). Also, to report quantitative values, the metric values' pace can be defined as the metric's average slope in FIG. 8 for both the AP and AN classifiers. The average slope values for weighted accuracy (ωAcc) and weighted F1 (ωf1), Cross f1, and Macro f1 are 8.70%, 8.78%, 4.36%, and 4.11%, respectively. For example, the rates of change are lower for Cross F1 and Macro F1 which indicates that these measurements are more stable and more useful for different levels of imbalance than weighted accuracy (ωAcc) and weighted F1 (ωf1).

Accordingly, Cross F1 and Macro F1 show lower rates of change when the class imbalance ratios change and this stability indicates that Cross F1 and Macro F1 are much more robust against biased tests sets then compared to weighted accuracy (ωAcc) and weighted F1 (ωf1).

In addition, unlike the weighted accuracy (ωAcc) and weighted F1 (f1) metrics that yield high scores in the AN classifier but low scores in the AP classifier, the Cross F1 metric considers the classifier's bias towards either the positive or negative class. This means that when evaluating the model with Cross F1, the model is penalized when the classifier favors one class over the other, and it ensures that equal importance is given to each class.

Further, additional insight is gained regarding the treatment of the positive and negative classes by each evaluation metric by analyzing the evaluation values of both AN and AP classifiers side-by-side (e.g., FIG. 8, left and middle). As can be seen, the evaluation values for the metrics weighted accuracy (ωAcc), weighted F1 (ωf1) and Macro F1 put high values for the AN classifier and low values for the AP classifier, which shows their bias towards the negative class.

Also, the AP and AN classifiers show different metrics behavior for varying levels of class imbalance in the testing set. Given that, an AP classifier can be converted to an AN classifier by simply reversing the labels, yet the weighted accuracy (ωAcc), weighted F1 (ωf1) and Macro F1 metrics exhibit an opposite behavior for each of them both in terms of attributed values and the changing pattern when the class imbalance ratio changes. In contrast, the Cross F1 metric exhibits comparable performance for both AN and AP classifiers, which is more advantageous. For instance, this comparable performance for both AN and AP classifiers shows that Cross F1 handles positive and negative classes equally.

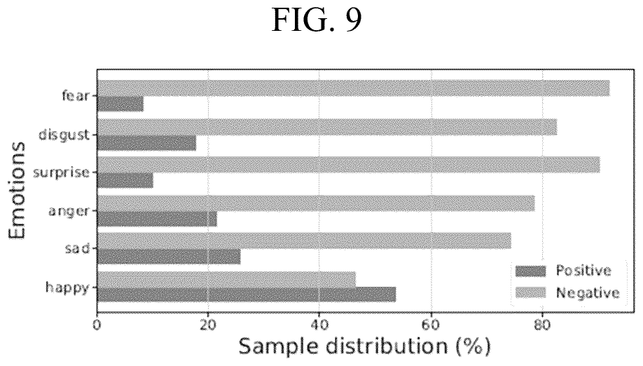

In addition, with reference to Table 1 below and FIG. 9, experiments were carried out using weighted accuracy (ωAcc), weighted F1 (ωf1), Cross F1, and Macro F1 to evaluate two different transformer based models on the CMU-MOSEI benchmark.

The first model that was used is the “Transformer-Based Joint Encoding” (TBJE) model, which consists of multiple modified transformer blocks that utilize information from different modalities while learning a single modality.

The second model that was used is the “Text-less Vision-Language Transformer” (TVLT) model, which employs a Vision transformer-based model with 16×16 patches from both video frames and audio spectrograms to learn a joint audio-visual representation.

CMU-MOSEI is a large-scale dataset for multi-label emotion recognition and sentiment analysis. CMU-MOSEI contains 3228 videos with 23,500 annotated sentences from 1000 speakers. The dataset includes six emotions: happiness, sadness, anger, fear, disgust, and surprise. FIG. 9 shows that some classes, such as fear and surprise, have imbalanced negative-to-positive ratios.

The TBJE model and the TVLT model were used to reproduce the results and the two models where evaluated against the weighted accuracy (ωAcc), weighted F1 (ωf1), Cross F1, and Macro F1 metrics. Also, the AN classifier was included due to its bias towards negative samples in the emotion class, which is a common issue in models trained without considering class imbalance.

TABLE 1

| | | | | | | | | Unweighted |
|---|---|---|---|---|---|---|---|---|
| Model | Metric | Happiness | Sadness | Anger | Fear | Disgust | Surprise | Average |
| AN Classifier | ωAcc | 45.91 | 75.66 | 76.73 | 90.54 | 82.57 | 91.74 | 77.17 |
| | ωf₁ | 28.89 | 65.17 | 66.63 | 86.05 | 74.69 | 87.79 | 68.17 |
| | f₁^{p} | 0 | 0 | 0 | 0 | 0 | 0 | 0 |
| | Macro f₁ | 31.46 | 43.07 | 43.42 | 47.52 | 45.23 | 47.85 | 43.08 |
| | Cross f₁ | 34.04 | 20.97 | 20.21 | 8.99 | 15.76 | 8.02 | 17.99 |
| TBJE | ωAcc | 61.71 | 68.89 | 72.18 | 84.85 | 79.88 | 88.07 | 75.93 |
| | ωf₁ | 61.77 | 68.22 | 70.76 | 84.19 | 79.53 | 86.59 | 75.17 |
| | f₁^{p} | 63.6 | 32.17 | 32 | 12.18 | 39.74 | 9.92 | 31.60 |
| | Macro f₁ | 61.61 | 55.99 | 57.25 | 51.94 | 63.83 | 51.76 | 57.06 |
| | Cross f₁ | 61.45 | 43.77 | 43.75 | 19.7 | 48.13 | 16.93 | 38.95 |
| TVLT | ωAcc | 60.21 | 75.8 | 76.94 | 90.54 | 82.82 | 91.69 | 79.67 |
| | ωf₁ | 59.07 | 65.43 | 67.19 | 86.05 | 75.52 | 87.61 | 73.50 |
| | f₁^{p} | 67.05 | 0.35 | 0.92 | 0 | 3.38 | 0 | 11.95 |
| | Macro f₁ | 58.42 | 43.29 | 43.94 | 47.52 | 46.97 | 47.81 | 47.99 |
| | Cross f₁ | 57.78 | 21.15 | 20.69 | 8.99 | 18.43 | 7.9 | 22.49 |

Table 1 above shows the results of evaluating the three models of AN classifier, TBJE, and TVLT on the CMU-MOSEI dataset using the five different metrics of weighted accuracy (ωAcc), weighted F1 (ωf1), Cross F1, and Macro F1.

As shown in the results in Table 1, while weighted accuracy (ωAcc) and weighted F1 (ωf1) indicate that the TVLT model outperforms the TBJE model in some of the emotion classes, such as fear and surprise, the TVLT model fails to detect most of the positive samples for those classes as reflected by the F1 score of the positive samples of the emotion class, f^{p}. However, the values for Cross F1 and Macro F1 clearly show this difference in the models' performance and attribute lower values for the TVLT model than the TBJE model. This can also be observed by comparing any of the TBJE and TVLT models with the AN classifier, where the values calculated for weighted accuracy (ωAcc) and weighted F1 (ωf1) indicate that the AN classifier outperforms both the TVLT model and the TBJE model for fear and surprise. The AN classifier fails to detect positive samples for those emotion classes.

Also, the three models can be compared by the unweighted average of the five metrics. The weighted accuracy (ωAcc) and weighted F1 (ωf1) metrics consider the TVLT model and the AN classifier to have a higher or comparable performance than the TBJE model. However, the Cross F1 and Macro F1 metrics show a clear decrease in performance among both models compared to the TBJE model. The results obtained from the CMU-MOSEI dataset are consistent with the outcomes of our experiments in FIG. 8 regarding how the different metrics behave in a class imbalance situation for a multi-label task.

Accordingly, the evaluation results show that the Cross F1 and Macro F1 metrics provide a more truthful insight into the models' performance than when evaluating the models with weighted accuracy (ωAcc) and weighted F1 (ωf1). Further, as discussed above, according to an embodiment, the method can include using a combination of both the Cross F1 and Macro F1 metrics, which can be even more advantageous when dealing with models trained on imbalanced data.

According to an embodiment, the AI device 100 can be configured as an audio assistance for a smart device. For example, the smart device can accurately evaluate audio based models on imbalanced samples, and can provide more a reliable AI model for assisting users.

According to another embodiment, the AI device 100 can be configured as a smart security system, which can provide improved evaluation metrics that can enhance the anomaly detection models in security cameras on imbalanced datasets, ensuring better detection of rare but critical events, such as break-ins or emergencies, thereby improving overall home security.

According to an embodiment, the AI device 100 can be configured as a patient monitoring system that uses the method to evaluate and select AI models related to health events, which often involve imbalanced data (e.g., rare health events).

According to another embodiment, the AI device 100 can be configured as a wearable device (e.g., a health monitoring wearable) that can evaluate and optimize models detecting irregular heartbeats or rare health anomalies, among other imbalanced datasets problems in the domain.

According to an embodiment, the AI device 100 can be configured as a recommendation system (e.g., a smart TV) that can use the improved evaluation metrics for recommending content to users.

According to another embodiment, the AI device 100 can be configured as a predictive maintenance system, such as an automotive solution for predictive maintenance that can benefit from better evaluation metrics to ensure accurate prediction of rare failure events, leading to proactive maintenance and reduced downtime.

According to an embodiment, the AI device 100 can be configured as a driver assistance system (e.g., Advanced Driver Assistance Systems ADAS) which can use the proposed metrics for evaluation and selection to ensure reliable detection and response to rare but critical driving scenarios.

According to an embodiment, the AI device 100 can be configured to answer user queries and/or recommend items (e.g., home appliance devices, mobile electronic devices, movies, content, advertisements or display devices, etc.), options or routes to a user. The AI device 100 can be used in various types of different situations.

According to one or more embodiments of the present disclosure, the AI device 100 can solve one or more technological problems in the existing technology by providing improved evaluation metrics that better represent an AI model's performance in multi-label classification settings that provide a more comprehensive assessment.

Further, the AI device 100 can solve technological problems in the existing technology by more effectively evaluating a best AI model from among a pool of available AI models to select for deployment, which can improve accuracy, ensure more reliable detection and response to rare but critical events, and accelerate the adoption of AI technologies across diverse fields.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, via a processor in the AI device, an AI model trained on a dataset that includes a majority class and at least one minority class;
generating, via the processor, at least one evaluation metric for the AI model based multiplying a first score for positive samples of a target class within the dataset by a number of negative samples of the target class within the dataset and multiplying a second score for the negative samples within the dataset by a number of the positive samples; and
outputting, via an output unit in the AI device, the at least one evaluation metric.

2. The method of claim 1, wherein the generating the at least one evaluation metric for the AI model includes:
generating a Cross F1 score for the AI model based on the dataset,
wherein the Cross F1 score is defined by equation:
$$Cross {f}_{1} = \frac{( {f}_{1}^{p} \times {N}^{n} ) + ( {f}_{1}^{n} \times {N}^{p} )}{{N}^{p} + {N}^{n}} ,$$
where f₁^{p} is an F1 score generated when measuring performance of the AI model on the positive samples, f₁ⁿ is an F1 score generated when measuring performance of the AI model on the negative samples, N^{p} is the number of the positive samples and Nⁿ is the number of the negative samples, and
wherein the F1 score is defined by equation:
$$F 1 Score = \frac{TP}{TP + \frac{1}{2} ( FP + FN )} ,$$
where TP is a number of true positives, FP is a number of false positives, and FN is a number of false negatives.

3. The method of claim 2, wherein the generating the at least one evaluation metric for the AI model further includes:
generating a Macro F1 score for the AI model based on the dataset,
wherein the Macro F1 score is defined by equation:
$$Macro {f}_{1} = \frac{{f}_{1}^{p} + {f}_{1}^{n}}{2} ,$$
and
wherein the at least one evaluation metric is based on both the Cross F1 score and the Macro F1 score.

4. The method of claim 2, wherein the Cross F1 score is a value between 0 and 1.

5. The method of claim 1, further comprising:
comparing the at least one evaluation metric to a predefined threshold value; and
in response to the at least one evaluation metric being greater than the predefined threshold value, deploying the AI model in a multi-label emotion recognition system, a question and answer system or a recommendation system.

6. A method for controlling an artificial intelligence (AI) device, the method comprising:
obtaining, via a processor in the AI device, a dataset that includes a majority class and at least one minority class;
training, via the processor, an AI model based on the dataset to generate a trained AI model;
generating, via the processor, an evaluation result for the trained AI model based on a Cross F1 metric and a Macro F1 metric;
in response to the evaluation result meeting or exceeding predefined criteria, adding the trained AI model to a pool of trained AI models trained on the dataset to generate an updated pool including a plurality of trained AI models;
selecting a selected AI model from among the plurality of trained AI models in the updated pool based on the Cross F1 metric and the Macro F1 metric; and
deploying the selected AI model in the AI device or transmitting the selected AI model to an external device.

7. The method of claim 6, wherein the Cross F1 metric is defined by equation:
$$Cross {f}_{1} = \frac{( {f}_{1}^{p} \times {N}^{n} ) + ( {f}_{1}^{n} \times {N}^{p} )}{{N}^{p} + {N}^{n}} ,$$
where f₁^{p} is an F1 score generated when measuring performance of the AI model on positive samples of a target class within the dataset, f₁ⁿ is an F1 score generated when measuring performance of the AI model on negative samples of the target class within the dataset, N^{p} is a number of the positive samples and Nⁿ is a number of the negative samples, and wherein the F1 score is defined by equation:
$$F 1 Score = \frac{TP}{TP + \frac{1}{2} ( FP + FN )} ,$$
where TP is a number of true positives, FP is a number of false positives, and FN is a number of false negatives, and
wherein the Macro F1 metric is defined by equation:
$$Macro {f}_{1} = \frac{{f}_{1}^{p} + {f}_{1}^{n}}{2} .$$

8. The method of claim 7, wherein the selecting the selected AI model is based on at least one of a highest average of the Cross F1 metric and the Macro F1 metric, applying different weight coefficients to the Cross F1 metric and the Macro F1 metric, a highest harmonic mean of the Cross F1 metric and the Macro F1 metric, and a highest weighted harmonic mean of the Cross F1 metric and the Macro F1 metric.

9. The method of claim 6, further comprising:
splitting the dataset into a training dataset, a validation dataset and a test dataset,
wherein the AI model trained based on the training dataset,
wherein the predefined criteria for adding the AI model to the pool is based on the validation dataset, and
wherein the deploying the selected AI model is based on an evaluation using the test dataset.

10. The method of claim 6, wherein the selected AI model is deployed in a multi-label emotion recognition system, a question and answer system or a recommendation system.

11. The method of claim 6, further comprising:
continuing training of the AI model until performance is satisfactory or until a predetermined number of iterations has been reached to generate the trained AI model, the continuing training of the AI model includes tuning hyper-parameters of the AI model; and
in response to the performance being satisfactory or when the predetermined number of iterations is reached, adding the trained AI model to the pool.

12. The method of claim 6, further comprising:
saving a checkpoint of the trained AI model in a memory of the AI device before generating the evaluation result for the trained AI model.

13. The method of claim 6, wherein the AI model is a multi-label emotion recognition configured to identify emotions including anger, disgust, fear, happiness, sadness and surprise, and
wherein the dataset is an imbalanced dataset including one or more of textual passages, images, audio recordings, and video recordings.

14. An artificial intelligence (AI) device, comprising:
a memory configured to store evaluation metrics; and
a controller configured to:
obtain a dataset that includes a majority class and at least one minority class, receive an AI model,
train the AI model based on the dataset to generate a trained AI model,
generate an evaluation result for the trained AI model based on a Cross F1 metric and a Macro F1 metric,
in response to the evaluation result meeting or exceeding predefined criteria, add the trained AI model to a pool of trained AI models trained on the dataset to generate an updated pool including a plurality of trained AI models,
select a selected AI model from among the plurality of trained AI models in the updated pool based on the Cross F1 metric and the Macro F1 metric, and
deploy the selected AI model in the AI device or transmit the selected AI model to an external device.

15. The AI device of claim 14, wherein the Cross F1 metric is defined by equation:
$$Cross {f}_{1} = \frac{( {f}_{1}^{p} \times {N}^{n} ) + ( {f}_{1}^{n} \times {N}^{p} )}{{N}^{p} + {N}^{n}} ,$$
where f₁^{p} is an F1 score generated when measuring performance of the AI model on positive samples of a target class within the dataset, f₁ⁿ is an F1 score generated when measuring performance of the AI model on negative samples of the target class within the dataset, N^{p} is a number of the positive samples and Nⁿ is a number of the negative samples, and
wherein the F1 score is defined by equation:
$$F 1 Score = \frac{TP}{TP + \frac{1}{2} ( FP + FN )} ,$$
where TP is a number of true positives, FP is a number of false positives, and FN is a number of false negatives, and
wherein the Macro F1 metric is defined by equation:
$$Macro {f}_{1} = \frac{{f}_{1}^{p} + {f}_{1}^{n}}{2} .$$

16. The AI device of claim 15, wherein the controller is further configured to:
select the selected AI model based on at least one of a highest average of the Cross F1 metric and the Macro F1 metric, applying different weight coefficients to the Cross F1 metric and the Macro F1 metric, a highest harmonic mean of the Cross F1 metric and the Macro F1 metric, and a highest weighted harmonic mean of the Cross F1 metric and the Macro F1 metric.

17. The AI device of claim 14, wherein the controller is further configured to:
split the dataset into a training dataset, a validation dataset and a test dataset,
wherein the AI model trained based on the training dataset,
wherein the predefined criteria for adding the AI model to the pool is based on the validation dataset, and
wherein the deploying the selected AI model is based on an evaluation using the test dataset.

18. The AI device of claim 14, wherein the controller is further configured to:
continue training of the AI model until performance is satisfactory or until a predetermined number of iterations has been reached to generate the trained AI model, the training of the AI model including tuning hyper-parameters of the AI model, and
in response to the performance being satisfactory or when the predetermined number of iterations is reached, add the trained AI model to the pool.

19. The AI device of claim 14, wherein the controller is further configured to:
saving a checkpoint of the trained AI model in the memory of the AI device before generating the evaluation result for the trained AI model.

20. The AI device of claim 14, wherein the AI model is a multi-label emotion recognition configured to identify emotions including anger, disgust, fear, happiness, sadness and surprise, and
wherein the dataset is an imbalanced dataset including one or more of textual passages, images, audio recordings, and video recordings.
